(19) United States
(12) Patent Application Publication
(10) Pub. No.: US 2022/0292060 A1
(43) Pub. Date: Sep. 15, 2022

(54) INFORMATION PROCESSING APPARATUS, SYSTEM, METHOD, AND NON-TRANSITORY RECORDING MEDIUM

(71) Applicant: Yuki Ito, Kanagawa (JP)

(72) Inventor: Yuki Ito, Kanagawa (JP)

(73) Assignee: Ricoh Company, Ltd., Tokyo (JP)

(21) Appl. No.: 17/653,702

(22) Filed: Mar. 7, 2022

(30) Foreign Application Priority Data
Mar. 11, 2021 (JP) 2021-038921

(51) Int. Cl. G06F 16/16; G06F 16/93; G06F 16/11

(52) U.S. Cl. CPC G06F 16/168; G06F 16/93; G06F 16/116

(57) ABSTRACT

An information processing apparatus, a system, a method, and a non-transitory recording medium. The information processing apparatus based on a determination that file information does not include a predetermined item, complements the predetermined item based on another item included in the file information, and displays on a display, the file information list including the predetermined item.

### CROSS-REFERENCE TO RELATED APPLICATIONS

This patent application is based on and claims priority pursuant to 35 U.S.C. § 119(a) to Japanese Patent Application No. 2021-038921, filed on Mar. 11, 2021, in the Japan Patent Office, the entire disclosure of which is hereby incorporated by reference herein.

### BACKGROUND

### Technical Field

The present disclosure relates to an information processing apparatus, a system, a method, and a non-transitory recording medium.

### Related Art

Recently, various cloud services are provided with the progress of information processing technology. For example, various information processing apparatuses can acquire a file stored in a storage residing on a network and execute various information processing such as editing and output.

### SUMMARY

Embodiments of the present disclosure describe an information processing apparatus, a system, a method, and a non-transitory recording medium. The information processing apparatus based on a determination that file information does not include a predetermined item, complements the predetermined item based on another item included in the file information, and displays on a display, the file information list including the predetermined item.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a schematic configuration of hardware of a system according to embodiments of the present disclosure;

FIG. 2 is a block diagram illustrating a hardware configuration of an information processing apparatus according to the embodiments of the present disclosure;

FIG. 3 is a block diagram illustrating a functional configuration of each information processing apparatus included in the system according to the embodiments of the present disclosure;

FIGS. 4A, 4B, and 4C are tables illustrating examples of file information stored in a storage unit according to the embodiments of the present disclosure;

FIG. 5 is a diagram illustrating data extraction when displaying a list of file information;

FIG. 6 is a diagram illustrating an example of a file information list displayed by an information processing apparatus according to a comparative example;

FIG. 7 is a flowchart illustrating a process of displaying the file information list according to the embodiments of the present disclosure;

FIGS. 8A, 8B, and 8C are diagrams illustrating a complement process of a file information item according to the embodiments of the present disclosure; and

FIG. 9 is a diagram illustrating an example of the file information list displayed by the information processing apparatus according to the embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure is not limited to the details of the example embodiments described below, and various modifications and improvements are possible. In the drawings for describing the following embodiments, the same reference numbers are allocated to elements (members or components) having the same function or shape and redundant descriptions thereof are omitted below.

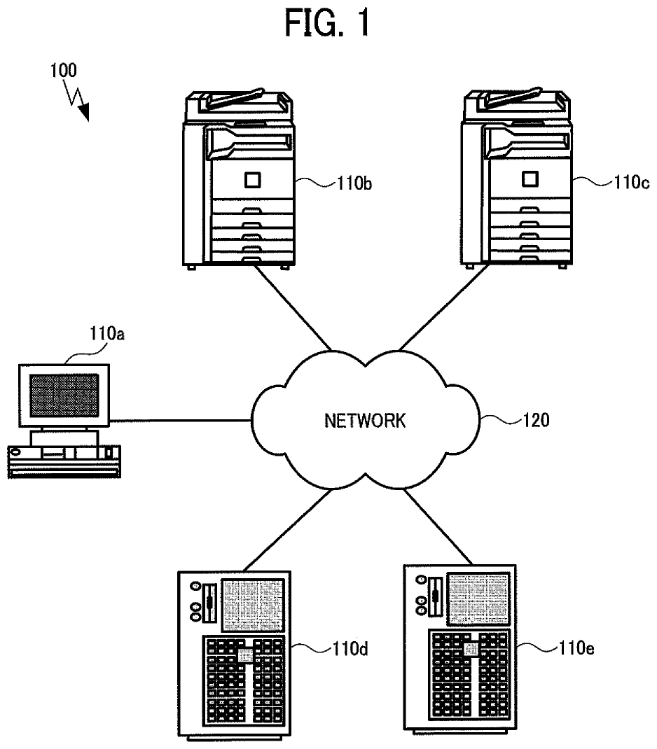

FIG. 1 is a diagram illustrating a schematic configuration of hardware of a system 100 according to the present embodiment. FIG. 1 illustrates, as an example, an environment in which a plurality of information processing apparatuses 110 are connected through a network 120 such as the internet or a local area network (LAN). The number of information processing apparatuses 110 included in the system 100 is not limited to the number illustrated in FIG. 1. Further, the connection of each information processing apparatus 110 to the network 120 may be either wired or wireless.

As illustrated in FIG. 1, the information processing apparatus 110 is an apparatus such as a personal computer 110a, image forming apparatuses 110b and 110c, servers 110d and 110e, etc., and stores various data and communicates with each other through the network 120. Further, the information processing apparatus 110 of the present embodiment can be provided with a display device for presenting various information to a user. A configuration of the information processing apparatus 110 illustrated in FIG. 1 is an example, and the configuration is not particularly limited. The information processing apparatus 110 other than an apparatus having the configuration illustrated in FIG. 1 may be included in the system 100.

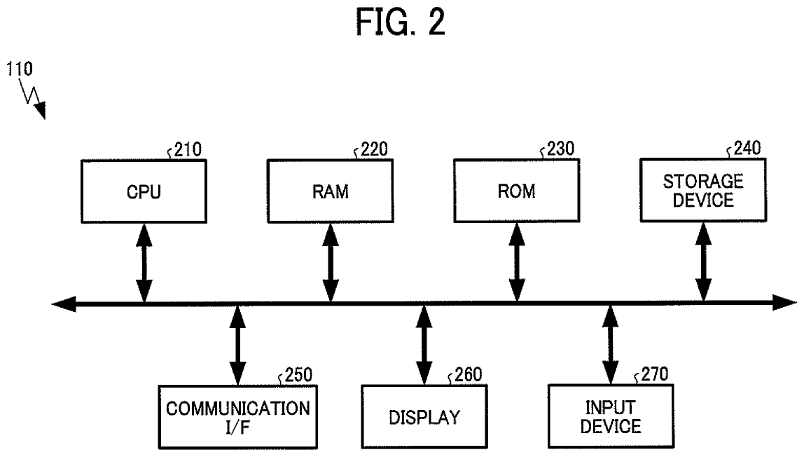

A description is now given of a hardware configuration of the information processing apparatus 110. FIG. 2 is a block diagram illustrating a hardware configuration of the information processing apparatus 110 according to the embodiments of the present disclosure. The information processing apparatus 110 includes a central processing unit (CPU) 210, a random access memory (RAM) 220, a read only memory (ROM) 230, a storage device 240, a communication interface (I/F) 250, a display 260, and an input device 270 connected to each other through a bus.

The CPU 210 is a device that executes a program that controls operation of the information processing apparatus 110 and performs processing. The RAM 220 is a volatile storage device that provides a storage area for programs executed by the CPU 210 and is used for storing and expanding programs and data. The ROM 230 is a non-volatile storage device for storing programs, firmware, and the like executed by the CPU 210.

The storage device 240 is a readable/writable non-volatile storage device that stores an operating system (OS) for causing the information processing apparatus 110 to function, various software, setting information, various files, data, and the like. Examples of the storage device 240 include a hard disk drive (HDD) and a solid state drive (SSD).

The communication I/F 250 connects the information processing apparatus 110 with the network 120 and enables communication with other devices through the network 120. The communication through the network 120 may be wired communication or wireless communication and various data are transmitted and received using a communication protocol such as Transmission Control Protocol/Internet Protocol (TCP/IP).

The display 260 is a device that displays various data, a state of the information processing apparatus 110, and the like to the user and examples thereof include a liquid crystal display (LCD). The input device 270 is a device for the user to operate the information processing apparatus 110, and examples thereof include a keyboard, a mouse, and the like. The display 260 and the input device 270 may be separate devices or may be incorporated into one device having both functions such as a touch panel display.

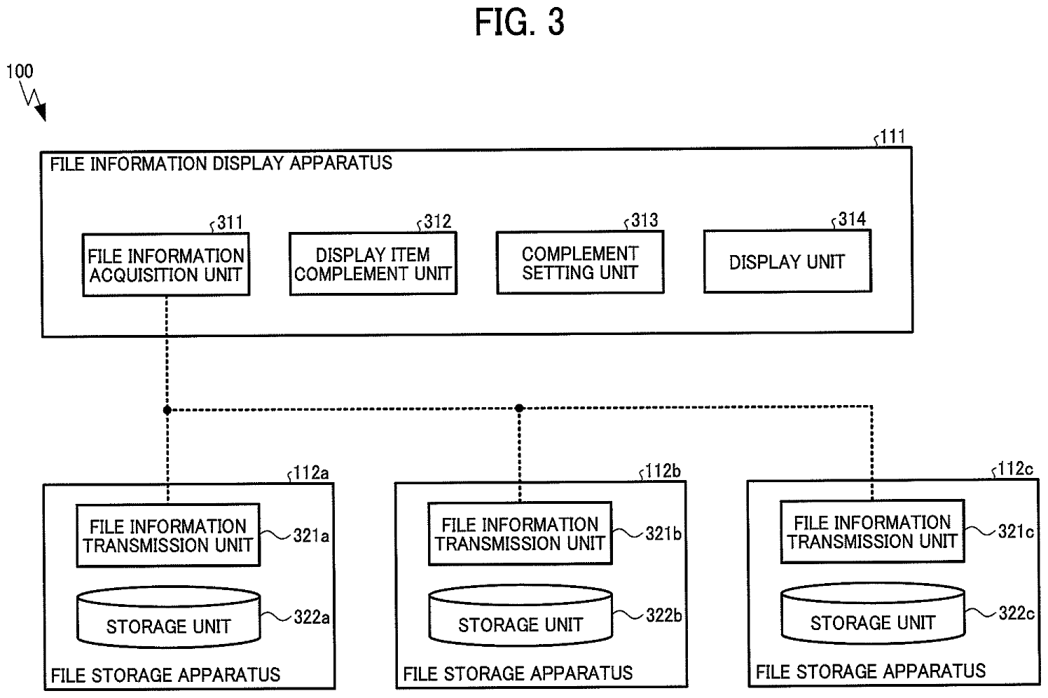

The hardware configuration of the information processing apparatus 110 according to the present embodiment is described above. A functional configuration implemented by each hardware in the present embodiment is described with reference to FIG. 3. FIG. 3 is a block diagram illustrating the functional configuration of each information processing apparatus 110 included in the system 100 according to the embodiments of the present disclosure.

FIG. 3 illustrates, as an example, a system 100 including one file information display apparatus 111 and three file storage apparatuses 112a to 112c. For the descriptive purposes, the storage apparatuses 112a to 112c may be collectively referred to as the storage apparatus 112. The file information display apparatus 111 and the file storage apparatus 112 are examples of the information processing apparatus 110, and the embodiment is not particularly limited. Further, the number of devices included in the system 100 is not limited to the number illustrated in FIG. 3.

First, the file information display apparatus 111 is described. The file information display apparatus 111 is an apparatus that acquires a plurality of pieces of file information and displays a list of predetermined items set in advance by the user. The file information display apparatus 111 of the present embodiment includes a file information acquisition unit 311, a display item complement unit 312, a complement setting unit 313, and a display unit 314. The file information display apparatus 111 may also include a functional unit corresponding to a storage unit 322 of the file storage apparatus 112, which is described below.

The file information acquisition unit 311 controls the communication OF 250 to acquire the file information stored in the storage unit 322 of the file storage apparatus 112 included in the system 100. The file information includes a file name, a created date and time, an update date and time, a creator, an identifier (ID), an attribute, a format, and the like related to the file, but the embodiment is not particularly limited. The file information acquisition unit 311 of the present embodiment can request file information from the file storage apparatus 112. Further, the file information acquisition unit 311 may be configured to acquire data related to the file together with the file information.

In the case the file information does not include an item set to be displayed in the list, the display item complement unit 312 complements the item based on another item. The display item complement unit 312 can complement the item to be complemented based on a complement method set by the complement setting unit 313.

The complement setting unit 313 sets a method of complementing the item by the display item complement unit 312. The complement setting unit 313 can make a setting such as “when the file information does not include the file format, the file format is complemented from an extension of the file name”.

The display unit 314 controls the display 260, converts each item of file information into a display format and displays as the list.

Next, the file storage apparatus 112 is described. The file storage apparatus 112 includes a file information transmission unit 321 and the storage unit 322.

The file information transmission unit 321 controls the communication OF 250, receives a file information request from the file information acquisition unit 311 of the file information display apparatus 111, and transmits file information stored in the storage unit 322.

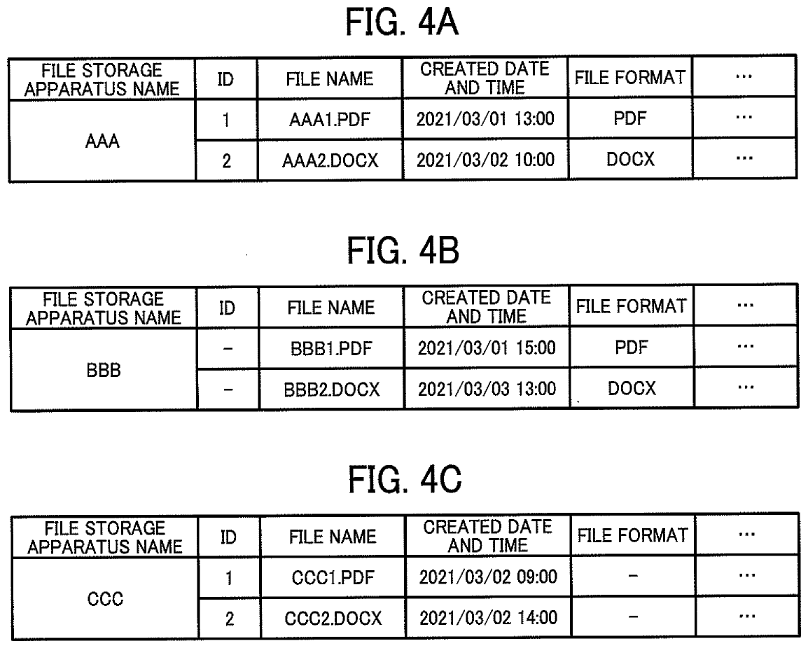

The storage unit 322 controls the storage device 240 and stores various files and file information related thereto in association with each other. Details of the file information included in the storage unit 322 is described with reference to FIGS. 4A, 4B, and 4C.

The functional configuration described above is implemented by the CPU 210 executing a program of the present embodiment to make each hardware function. Further, all of the functional units described in each embodiment may be implemented by software, or part or all of the functional units may be implemented as hardware that provides equivalent functions.

Furthermore, all of the functional units described above do not necessarily be included in the configuration illustrated in FIG. 3. For example, in another preferred embodiment, each functional units may be implemented by a cooperation of a plurality of information processing apparatuses 110.

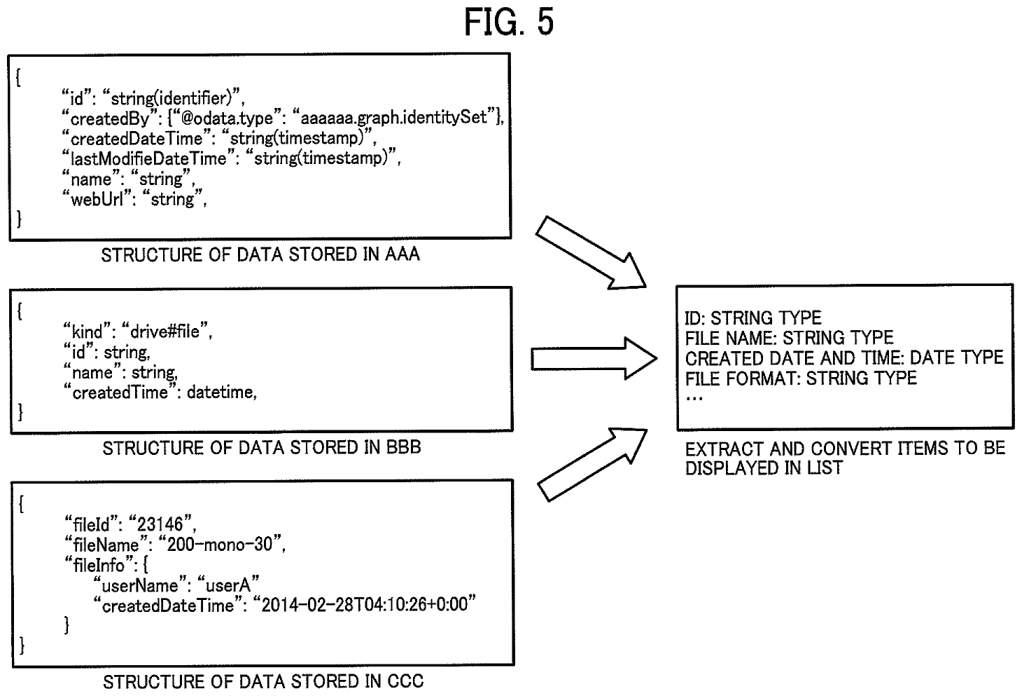

The details of the functional configuration of the present embodiment is described. The display of the list of the file information according to the present embodiment is described with reference to FIGS. 4A, 4B, 4C, and 5. FIGS. 4A, 4B, and 4C are tables illustrating examples of file information stored in the storage unit 322 according to the embodiments of the present disclosure. Further, FIG. 5 is a diagram illustrating data extraction when displaying the file information list.

File information as illustrated in FIGS. 4A, 4B, and 4C is stored in the storage unit 322. FIGS. 4A, 4B and 4C illustrate an example in which file information is stored in the storage unit 322 of the three file storage apparatuses 112a to 112c (referred to as “AAA”, “BBB”, and “CCC” for convenience).

File information including the ID, the file name, the created date and time, and the file format is stored in the storage unit 322a of “AAA”. File information including the file name, the created date and time, and the file format is stored in the storage unit 322b of the “BBB”. File information including the ID, the file name, and the created date and time is stored in the storage unit 322c of the “CCC”.

A case where items of the ID, the file name, the created date and time, and the file format is displayed in the list is described with reference to FIG. 5. As illustrated in FIG. 5, the data structure of the file information stored in each file storage apparatus 112 may be different. Therefore, as illustrated in FIG. 5, a process of extracting the items to be displayed in the list and converting the items into a common display format is performed. For example, the “ID” is extracted and converted as a “string type”, and the “created date and time” is extracted and converted as a “date type”.

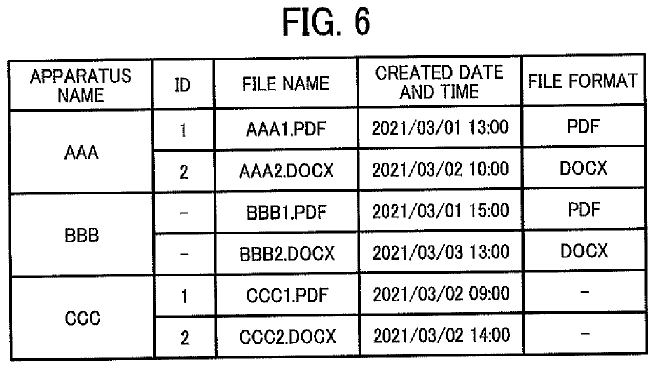

As described with reference to FIGS. 4A, 4B, and 4C, an item included in the file information of a certain apparatus may not be included in the file information of another apparatus. For example, when displaying the file information list including the ID, the file name, the created date and time, and the file format, in the example of FIGS. 4A, 4B, and 4C, AAA includes all items, but BBB does not include “ID”, and CCC does not include “file format”. In the case of technique in a comparative example, missing items cannot be extracted from the file information of BBB and CCC, and in the list displayed as a result, some items are missing as illustrated in FIG. 6.

FIG. 6 is a diagram illustrating an example file information list displayed by a general information processing apparatus in the comparative example. As illustrated in FIG. 6, when the file information that is similar to the file information illustrated in FIGS. 4A, 4B, and 4C is displayed as the file information list by the general information processing apparatus, the item “ID” of the BBB and the item “file format” of the CCC are not displayed. The user may not be able to properly select a file from the displayed list, which causes inconvenience. In the present embodiment, when the predetermined item is not stored, the file information is displayed in the list after performing a process of complementing from another item.

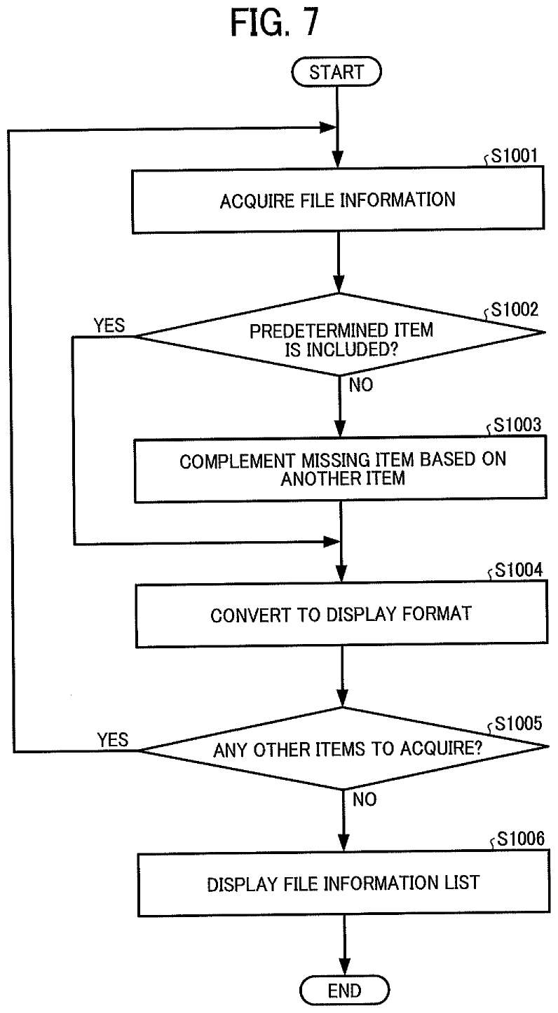

FIG. 7 is a flowchart illustrating a process of displaying the file information list in the present embodiment. The file information display apparatus 111 starts the process. In step S1001, the file information acquisition unit 311 acquires the file information from the file storage apparatus 112. The file information acquired in step S1001 may not be acquired from the file storage apparatus 112, and may be acquired from, for example, a local storage in the file information display apparatus 111.

In step S1002, the process branches depending on whether the acquired file information includes the predetermined items. In the case the acquired file information includes all the items to be displayed in the list (YES), the process proceeds to step S1004.

In step S1002, in the case the file information does not include all the predetermined items, for example, when the ID is set as the predetermined item to be displayed in the list and the acquired file information does not include the ID (NO in step 1002), the process proceeds to step S1003. In step S1003, the display item complement unit 312 complements a missing item based on another item included in the file information. When there are a plurality of the predetermined items that are not included in the file information, the display item complement unit 312 complements each item.

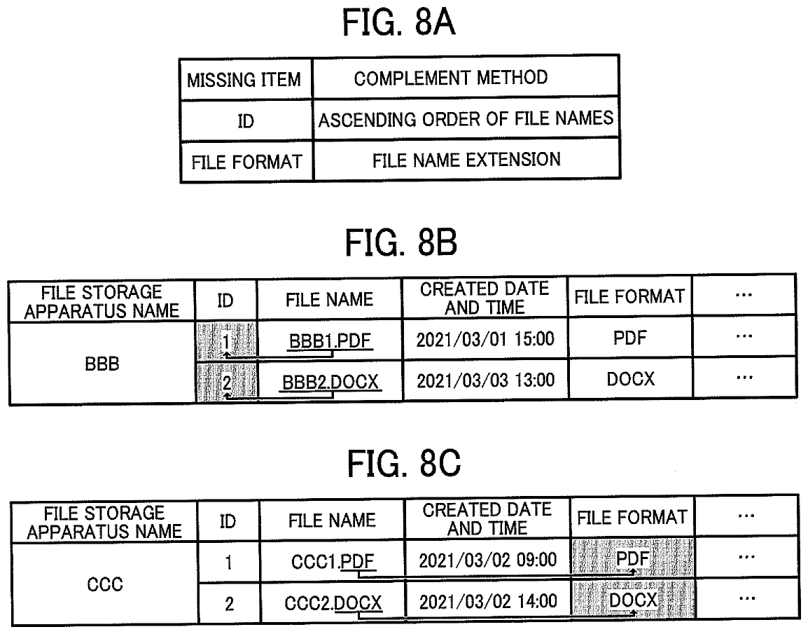

The details of a complement process in step S1003 is described with reference to FIGS. 8A, 8B, and 8C. FIGS. 8A, 8B, and 8C are diagrams illustrating the complement process of the file information item according to the embodiments of the present disclosure. FIG. 8A is a table in which a method for complementing items missing in file information is set (hereinafter referred to as a “complement method table”). The complement method table can be set by the complement setting unit 313. In the example of FIG. 8A, when the ID is missing in the file information, the complement method is set to complement the ID based on ascending order of the file names, and when the file format is missing in the file information, the complement method is set to complement the file format based on the file name extension. The complement method is not limited to the methods illustrated in FIG. 8A and can be set to any method according to the items.

A case where the complement method set as illustrated in FIG. 8A is applied to the file information of FIGS. 4A, 4B, and 4C for complementation is described. Here, it is assumed that items of the ID, the file name, the created date and time, and the file format are to be displayed in the list.

First, FIG. 8B is described. In the case of the BBB of FIG. 4B, since the ID is missing in the file information, the file information is complemented based on the ascending order of the file names. The display item complement unit 312 with reference to the complement method table complements the file information of “bbb1.pdf” with the ID “1” and complements the file information of “bbb2.docx” with the ID “2”. Accordingly, the file information is complemented as in dark colored items of FIG. 8B.

Next, FIG. 8C is described. In the case of the CCC of FIG. 4C, since the file format is missing in the file information, the file information is complemented based on the extension of the file name. The display item complement unit 312 with reference to the completion method table complements the file information of “bbb1.pdf” with the file format “pdf” and complements the file information of “bbb2.docx” with the file format “docx”. Accordingly, the file information is complemented as in the dark colored items of FIG. 8C.

The description returns to FIG. 7. After complementing the file information in step S1003, the process proceeds to step S1004. In step S1004, the display unit 314 converts the file information into a display format. The display format is defined in a format such as a string type or a date type.

In step S1005, the process branches depending on whether there is another file information to be acquired to display as the list. When there is another file storage apparatus 112 to be acquired (YES), the process returns to step S1001 and the process of steps S1001 to S1004 described above is repeated. When there is no other file storage apparatus 112 to be acquired (NO), the process proceeds to step S1006.

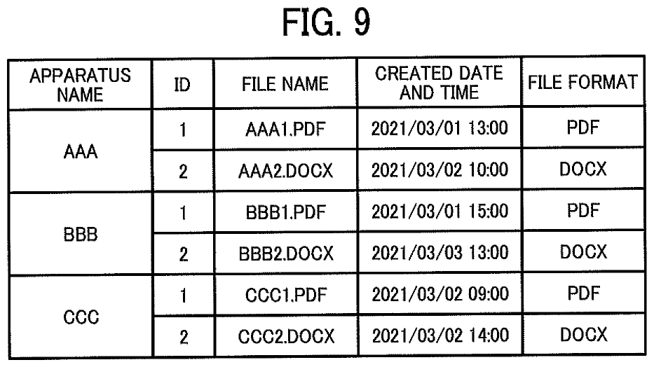

In step S1006, the display unit 314 displays the file information list. In step S1006, for example, a screen including the table as illustrated in FIG. 9 is displayed. FIG. 9 is a diagram illustrating an example in which the information processing apparatus 110 of the present embodiment displays the file information list. In the example illustrated in FIG. 9, the file information list appropriately including the predetermined items (ID, file name, created date and time, file format) is displayed. That is, the file information is improved as compared with the example illustrated in FIG. 6 and the file information that is convenient for the user can be displayed in the list.

The description returns to FIG. 7 again. After displaying the file information list in step S1006, the file information display apparatus 111 ends the process.

By the above-mentioned processing, the information processing apparatus 110 of the present embodiment can appropriately complement the file information even when the file information does not include the predetermined items to be displayed and can display the file information list with improved quality.

According to the embodiment of the present disclosure described above, it is possible to provide an information processing apparatus, a system, a method and a program for appropriately listing file information.

Each function in the exemplary embodiment may be implemented by a program described in C, C++, C# or JAVA (registered trademark). The program may be provided using any storage medium that is readable by an apparatus, such as a hard disk drive, compact disc (CD) ROM, magneto-optical disc (MO), digital versatile disc (DVD), a flexible disc, erasable programmable read-only memory (EPROM), or electrically erasable PROM. Alternatively, the program may be transmitted through network such that other apparatus can receive the program.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing apparatus for displaying a file information list, the information processing apparatus comprising circuitry configured to:
based on a determination that file information does not include a predetermined item, complement the predetermined item based on another item included in the file information; and
display on a display, the file information list including the predetermined item.

2. The information processing apparatus of claim 1, wherein
the circuitry is further configured to acquire the file information through a network.

3. The information processing apparatus of claim 2, wherein
the circuitry is further configured to acquire the file information from a plurality of other information processing apparatuses.

4. The information processing apparatus of claim 1, wherein
the circuitry is further configured to complement the predetermined item based on complement settings set by associating the predetermined item with the another item.

5. A system comprising a plurality of information processing apparatuses including at least one information processing apparatus for displaying a file information list, the at least one information processing apparatus including circuitry configured to:
based on a determination that file information does not include a predetermined item, complement the predetermined item based on another item included in the file information; and
display on a display, the file information list including the predetermined item.

6. A method of displaying a file information list, the method comprising:
acquiring the file information;
based on a determination that file information does not include a predetermined item, complementing the predetermined item based on another item included in the file information; and
displaying on a display, the file information including the predetermined item in a list.

7. A non-transitory recording medium storing a plurality of instructions which, when executed by one or more processors, causes the processors to perform the method of claim 6.
